(19) United States
(12) Patent Application Publication
(10) Pub. No.: US 2024/0407627 A1
(43) Pub. Date: Dec. 12, 2024

(54) Collecting hair assembly and collecting hair machine

(71) Applicant: SHENZHEN LALAHOME SMARTECH CO.,LTD., Shenzhen City (CN)

(72) Inventors: Jishu Xu, Shenzhen City (CN); Yanjiatai Wei, Shenzhen City (CN); Zhixing Wei, Shenzhen City (CN); Guohong Tan, Shenzhen City (CN)

(73) Assignee: SHENZHEN LALAHOME SMARTECH CO.,LTD., Shenzhen City, OT (CN)

(21) Appl. No.: 18/733,521

(22) Filed: Jun. 4, 2024

(30) Foreign Application Priority Data
Jun. 9, 2023 (CN) 202310685905.6

(51) Int. Cl. A47L 25/00

(52) U.S. Cl. CPC A47L 25/005

(57) ABSTRACT

The present invention discloses a collecting hair assembly and a collecting hair machine, and relates to the technical field of a cleaning appliance. The collecting hair assembly includes a first barrel, a second barrel, and a controller. A collecting hair component is sleeved at a first connecting part of the first barrel. The free end of the collecting hair component is connected to a second connecting part of the second barrel. The second barrel is provided with a driver. The collecting hair machine includes a housing and the forgoing collecting hair assembly. The housing is provided with a collecting hair operating opening. The first barrel protrudes wholly or partially out of the collecting hair operating opening. Compared with the prior art, the collecting hair assembly and the collecting hair machine can achieve flexible selection of the using section of the collecting hair component by using the controller, without frequent manual replacement of an adhering paper, and with a high degree of intelligentization.

### REFERENCE TO PRIOR APPLICATION

This application claims priority to Chinese Patent Application 202310685905.6, filed on Jun. 9, 2023, which is incorporated herein by reference.

### TECHNICAL FIELD

The present invention relates to the technical field of a cleaning appliance, and specifically, to a collecting hair assembly and a collecting hair machine.

### BACKGROUND

In daily hair cleaning, a hair collector, as an important tool for cleaning hairs in recent years, can clean adhered hairs in a centralized manner more quickly and conveniently. However, most of hair collectors in the prior art use a mode for manually changing paper, i.e. an adhering paper that has adhered hairs is manually replaced, which is less convenient in use. Especially for large-area adhered hairs, the hair collector requires frequent manual replacement of the adhering paper.

In view of this, the present application is proposed.

### SUMMARY

A first objective of the present invention is to provide a collecting hair assembly. The collecting hair assembly utilizes a double-barrel form to achieve the objective of continuous work of a collecting hair component, without frequent replacement of an adhering paper for a large-area hair adhered scene.

A second objective of the present invention is to provide a collecting hair machine. The collecting hair machine utilizes the forgoing collecting hair assembly and can facilitate continuous and reciprocal collecting and suction hair operations for a collecting hair region. A collecting hair component can be selectively continuously used or used by directly replacing a next section, with a higher degree of automation.

An embodiment of the present invention is realized as follows:

In a first aspect, a collecting hair assembly includes a first barrel, a second barrel, and a controller. The first barrel has a first connecting part for being sleeved at the collecting hair component. The first barrel can be auto-rotated along the axis of the first barrel so that the collecting hair component can contact a collecting hair region reciprocally in a first rolling direction. The second barrel has a second connecting part connected to the free end of the collecting hair component. The second barrel is provided with a driver. The driver can drive the second barrel to auto-rotate along the axis of the second barrel so that the free end can be wound or disengaged from the second barrel in a second rolling direction. The controller is connected to the driver via signals for controlling the operation of the driver when the controller is triggered by the signals. The free end can be selectively wound or disengaged from the second barrel when the collecting hair component is rotated clockwise or counterclockwise in the first rolling direction in a signal-triggered state.

In an optional embodiment, the axes of the first barrel and the second barrel are parallel to each other.

In an optional embodiment, the first barrel is provided therein with an elastic damping structure; and/or, the second barrel is provided therein with the elastic damping structure. The elastic damping structure includes a support shaft and a spring. The support shaft is coaxially arranged inside the corresponding barrel. The spring is fixed between the support shaft and the corresponding barrel.

In an optional embodiment, the first barrel includes a first barrel body and a first position limiting cover movably snap-fitted to one end of the first barrel; and/or, the second barrel includes a second barrel body and a second position limiting cover movably snap-fitted to one end of the second barrel.

In an optional embodiment, the side wall of the open end of the first barrel body extends to form a plurality of first snap-fit strips. The first snap-fit strips are arranged in an axial direction of the first barrel body. A first plug-in barrel is provided on one side of the first position limiting cover. A plurality of first elastic protrusions are provided on the first plug-in barrel. The first elastic protrusions are configured to be snap-fitted with the first snap-fit strips during snap-fit;

and/or, the side wall of the open end of the second barrel body extends to form a plurality of second snap-fit strips. The second snap-fit strips are arranged in an axial direction of the second barrel body. A second plug-in barrel is provided on one side of the second position limiting cover. A plurality of second elastic protrusions are arranged on the second plug-in barrel. The second elastic protrusions are configured to be snap-fitted with the second snap-fit strips during the snap-fit.

In a second aspect, a collecting hair machine includes a housing and the forgoing collecting hair assembly. One side of the housing is opened and provided with a collecting hair operating opening. The collecting hair assembly is mounted in the housing. The first barrel of the collecting hair assembly is rotatably provided at the collecting hair operating opening. The first barrel protrudes wholly or partially out of the collecting hair operating opening so that the collecting hair component can contact a collecting hair region.

In an optional embodiment, the collecting hair machine further includes a steering determining device connected to the controller via signals. The steering determining device is configured to detect the direction of autorotation of the first barrel.

In an optional embodiment, the collecting hair machine further includes a rotation speed device connected to the controller via signals. The rotation speed determining device is configured to detect a rotation speed of the first barrel.

In an optional embodiment, the housing is provided with an outer cover for protecting the steering determining device and/or the rotation speed determining device. The outer cover is movably snap-fitted with the housing.

In an optional embodiment, the housing is rotatably snap-fitted with a housing movable cover. The housing movable cover and the outer cover are located on two sides of the housing, respectively.

In an optional embodiment, the housing is provided with a tensioning roller. The tensioning roller is located in a direction of a connecting line between the first barrel and the second barrel. The tensioning roller is configured to tension a part of the collecting hair component connected between the first barrel and the second barrel.

In an optional embodiment, the housing is provided therein with a deflection roller. The deflection roller is configured to limit the part of the collecting hair component connected between the first barrel and the second barrel.

In an optional embodiment, both the upper and lower ends of a deflection-correcting roller are connected to the housing in a penetrating plug-in manner.

In an optional embodiment, the housing is opened and provided with an operating opening connected to an inner cavity of the housing. The operating range of the operating opening covers at least the first barrel, the second barrel, and an intermediate connecting region between the first barrel and the second barrel.

In an optional embodiment, the housing is connected to a sealing cover that movably seals and covers the operating opening.

In an optional embodiment, the housing is integrated with a handle. The handle is located on the side of the housing away from a collecting hair operating opening. The handle includes a first housing and a second housing that are capable of removably cooperating with each other. One end of the first housing and one end of the second housing are connected to the inner side wall of the housing.

In an optional embodiment, the first barrel and/or the second barrel is connected to the housing via a bearing.

The embodiment of the present invention has the following beneficial effects of:

The collecting hair assembly provided by the embodiment of the present invention is provided with the first barrel and the second barrel. The first barrel can drive the collecting hair component to rotate reciprocally. The free end of the collecting hair component is connected to the second barrel. Therefore, the retracting action of the second barrel can be utilized to realize the form that the collecting hair component uses any section. The second barrel is controlled to rotate clockwise or counterclockwise with or without the controller being triggered, so as to achieve the objective of automatic replacement of the use section of the collecting hair component.

The collecting hair machine provided by the embodiment of the present invention utilizes the forgoing collecting hair component and integrates the collecting hair assembly within the housing. This achieves a convenient form of cleaning the collecting hair region, has the advantage that the collecting hair assembly automatically replaces the collecting hair component, and can cope with a large-area collecting, suction and cleaning scene.

In general, compared with a single-barrel hair collector in the prior art, the collecting hair assembly and the collecting hair machine provided by the embodiment of the present invention utilize the controller to realize the flexible selection of the use section of the collecting hair component, and can selectively and repeatedly use the used section of the collecting hair component or the new section of the collecting hair component without frequent manual replacement of the adhered paper, with a high degree of intelligentization.

### BRIEF DESCRIPTION OF DRAWINGS

In order to more clearly describe the technical solutions of embodiments of the present invention, the following briefly introduce the drawings that need to be used in the embodiments of the present invention. It should be understood that the following drawings only show certain embodiments of the present invention and should not be regarded as a limitation of the scope. The person skilled in the art can obtain other related drawings based on these drawings without creative work.

FIG. 1 is a schematic structural diagram of a collecting hair assembly provided by an embodiment of the present invention;

FIG. 2 is a schematic structural diagram of an overall structure of a collecting hair machine provided by an embodiment of the present invention;

FIG. 3 is a partial schematic structural diagram I of a collecting hair machine shown in FIG. 2;

FIG. 4 is a partial schematic structural diagram II of a collecting hair machine shown in FIG. 2;

FIG. 5 is a partial schematic structural diagram III of a collecting hair machine shown in FIG. 2;

FIG. 6 is a schematic diagram of the connection between a barrel body and a position limiting cover provided by an embodiment of the present invention;

FIG. 7 is a schematic structural diagram of a handle provided by an embodiment of the present invention;

FIG. 8 is a schematic structural diagram of the installation of an outer cover in a movable snap-fit manner of the present invention;

FIG. 9 is a schematic structural diagram 1 of the installation of an outer cover in a turn-knob snap-fit manner of the present invention;

FIG. 10 is a schematic structural diagram 2 of the installation of an outer cover in a turn-knob snap-fit manner of the present invention;

FIG. 11 is a schematic structural diagram 3 of the installation of an outer cover in a turn-knob snap-fit manner of the present invention.

Reference signs: 100—housing; 101—handle; 102—collecting hair operating opening; 103—outer cover; 104—sealing cover; 200—collecting hair assembly; 201—first barrel; 202—second barrel; 203—mounting end; 204—tensioning roller; 205—deflection roller; 206—elastic damping structure; 207—driver; 300—collecting hair component; 400—collecting hair region; 1011—first housing; 1012—second housing; 1013—connecting end; 1031—outer cover body; 1032—guide column; 1033—buckled female member; 1034—buckled submember; 1035—outer cover plate; 2011—first snap-fit strip; 2012—first elastic protrusion.

### DETAILED DESCRIPTION OF EMBODIMENTS

In order to make the objective, technical solutions and advantages of the embodiments of the present invention clearer, the technical solutions in the embodiments of the present invention will be clearly and completely described below in conjunction with the accompanying drawings in the embodiments of the present invention, and it is clear that the embodiments described are a part of the embodiments of the present invention, and not all of them. The components of the embodiments of the present invention generally described and illustrated in the drawings herein can be arranged and designed in various different configurations.

Therefore, the following detailed description of the embodiments of the present invention provided in the drawings is not intended to limit the scope of the claimed invention, but merely represents selected embodiments of the present invention. Based on the embodiments of the present invention, all other embodiments obtained by those skilled in the art without creative labor should fall within the protection scope of the present invention.

It should be noted that similar reference numerals and letters indicate similar items in the following drawings. Therefore, once a certain item is defined in one drawing, the item does not need to be further defined and explained in the subsequent drawings.

In the description of the present invention, it should be explained that the azimuthal or positional relationships indicated by the terms “center”, “upper”, “lower”, “left”, “right”, “vertical”, “horizontal”, “inner”, “outer” and the like are based on the azimuthal or positional relationships shown in the drawings, or are the azimuthal or positional relationships customarily placed when used in a product of the present invention, only for the convenience of describing the present invention and simplifying the description, and not to indicate or imply that a device or an element referred to should have a specific orientation, be constructed and operated in a specific orientation, and thus cannot be understood as limiting to the present invention. Further, the terms “first”, “second”, “third”, and the like are used only to distinguish among descriptions and cannot be construed as an indication or implication of relative importance.

In addition, the terms “parallel”, “perpendicular”, etc. do not imply that the parts are required to be absolutely parallel or perpendicular, but can be slightly inclined. For example, “parallel” simply means that a direction is more parallel compared to “perpendicular”, and does not mean that a structure has to be completely parallel, but can be slightly inclined.

Terms such as “roughly” and “substantially” are intended to indicate that relevant contents are not absolutely precise, but can deviate to a certain extent. For example, “substantially equal” does not only mean absolute equality. Because it is difficult to achieve absolute “equality” in an actual production and operation process, there are generally certain deviations. Therefore, in addition to absolute equality, “approximately equal” also includes the forgoing cases where there are certain deviations. In this case, unless otherwise specified, the terms “approximately”, “substantially” and so on have the same meaning as above.

In the description of the present invention, it is also to be noted that the terms such as “arranged”, “mounted”, “interconnected”, “connected” should be understood in a general sense. For example, these technical terms may be a fixed connection, a detachable connection, or an integrated connection; or may be a direct connection, an indirect connection by using an intermediate medium, or an internal communication of two elements. The person skilled in the art may understand specific meanings of the foregoing terms in the present invention according to a specific situation.

A previous collecting hair apparatus mainly utilizes an adhering paper wound to a paper tube. The outer side of the adhering paper is a collecting and suction surface. After each use, the adhering paper needs to be manually (torn off) be replaced, leaving the next section of new adhering paper. Although a collecting hair operation can be continued, for a large-area collecting and adhering scene, the frequent replacement of the adhering paper increases labor intensity and operation trouble. Further if the adhering paper is (accidentally) torn off, it is difficult to mount the adhering paper on collecting hair machine again to continue to use, with a low degree of intelligentization. In response to this problem, this embodiment provides a collecting hair assembly. The collecting hair assembly can flexibly select whether to repeatedly use a current section of the collecting hair component or to use the next section of the new collecting hair component according to the direction of use of collection and suction.

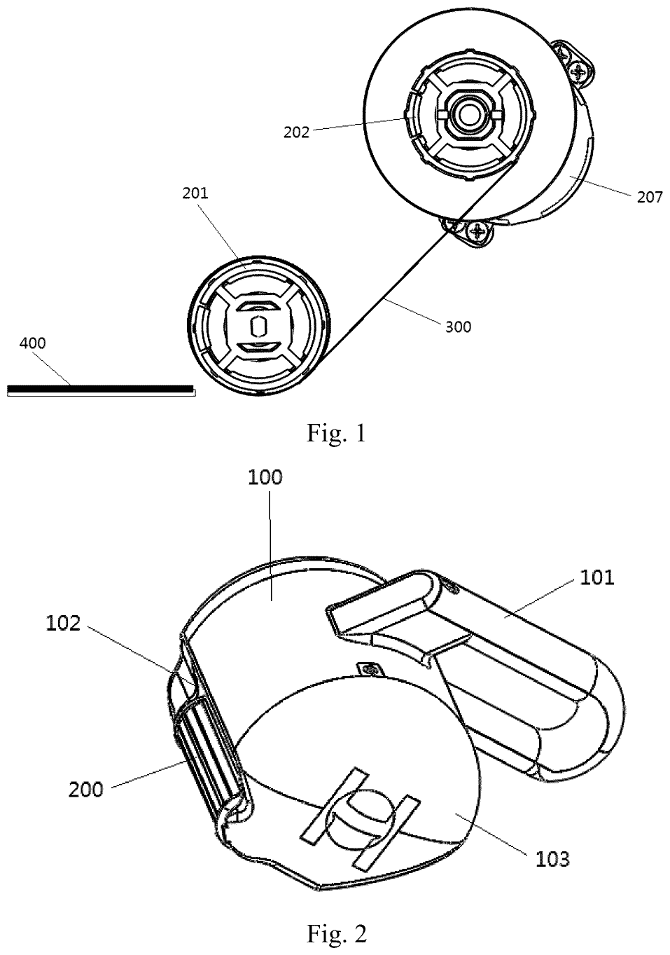

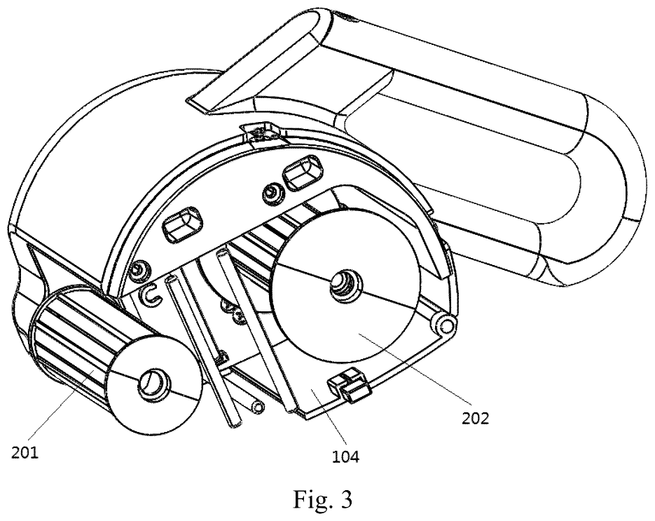

Referring specifically to FIGS. 1 and 2, this embodiment provides a collecting hair assembly 200, including a first barrel 201, a second barrel 202, and a controller. The first barrel 201 has a first connecting part for being sleeved at a collecting hair component 300, i.e., it is indicated that the collecting hair component 300 is sleeved and mounted on the first connecting part of the first barrel 201, so as to be able to have the condition of following the rotation of the first barrel 201. Specifically, the first barrel 201 can auto-rotate along the axis of the first barrel. The autorotation herein can be a passive rotation under the action of an external force or an active rotation under the action of a driving component, so that the collecting hair component 300 can reciprocally contact a collecting hair region 400 along a first rolling direction.

It should be noted that the collecting hair component 300 herein refers mainly to a rotary body with a collecting and suction surface, for example a structure with the adhering paper sleeved on a paper tube, so as to be able to follow the first barrel 201 to reciprocally rotate in the first rolling direction. The first rolling direction can be clockwise or counterclockwise. Specifically, in some embodiments, the first connecting part is a structure formed by the side ring surface of the first barrel 201, which can be fixed to the sleeved collecting hair component 300. Therefore, when the first barrel 201 auto-rotates, the collecting hair component 300 can be rotated clockwise or counterclockwise, so as to reciprocally contact the collecting hair region 400 and fully complete collecting and suction operations.

The second barrel 202 has a second connecting part connected to the free end of the collecting hair component 300. The free end of the collecting hair component 300 mainly refers to the free end of the adhering paper or a movable component loaded with the adhering paper. Taking as an example the free end of the adhering paper, the free end is fixed to the second connecting part of the second barrel 202 and thus has the condition of follow the movement of the second barrel 202. The second connecting part herein is mainly the part of the second barrel 202 that is capable of rotation.

The second barrel 202 can be passively rotated by an external force or actively rotated by a drive component, which are both used here, i.e. the second barrel 202 is provided with a driver 207. The driver 207 can drive the second barrel 202 to auto-rotate along the axis of the second barrel, so that the free end can be wound or disengaged from the second barrel 202 in a second rolling direction (here, the second rolling direction also means a clockwise or counterclockwise direction, in different embodiments, the axis of the first rolling direction and the axis of the second rolling direction may be parallel or non-parallel). The forgoing driver 207 can be a conventional combined structure that can achieve rotary motion, such as a drive motor, a slider crank structure, a rack and pinion structure, a motor filament assembly, with the aim of being able to drive the second barrel 202 to reciprocally auto-rotate along the axis of the second barrel.

The controller is connected to the driver 207 via signals for controlling the operation of the driver 207 when the controller is triggered by the signals. The signal trigger means that collecting hair signals are collected and parsed by the controller to give operation instructions. The collecting hair signals can be contact pressure signals, motion direction signals, motion speed signals or moving displacement signals, etc. In this embodiment, taking as an example the motion direction signals, when the motion direction signals are collected so that the first barrel 201 is rotated clockwise or counterclockwise. The controller controls the driver 207 to act, so that the second barrel 201 is rotated synchronously clockwise or counterclockwise, that is, in a signal-triggered state, when the collecting hair component 200 is rotated clockwise or counterclockwise in the first rolling direction, the free end can be selectively wound or disengaged from the second barrel 202.

With the forgoing technical solution, by utilizing the situation that the first barrel 201 is rotated clockwise or counterclockwise when in use, it is determined whether the collecting hair component 300 needs to be wound or released at this time. Therefore, in some use scenes, for example, when the first barrel 201 is controlled to collect and suck the collecting hair region 400 clockwise, the controller drives the driver 207 to rotate clockwise. Therefore, the second barrel 202 rotates clockwise synchronously. The free end is released (the collecting hair component 300 is gradually disengaged from the second barrel 202 and wound onto the first barrel 201) so that the current section of the free end 300 of the collecting hair component 300 is used repeatedly or the previously used section continues to be reused. When the first barrel 201 is controlled to collect and suck the collecting hair region 400, the controller drives the driver 207 to reverse. Therefore, the second barrel 202 is rotated counterclockwise synchronously and rewinds the free end, thus achieving the objective of using the use section of the collecting hair component 300 (the direction of rotation of the first barrel 201 and the second barrel 202 is optional).

According to an operation mode in different use scenes, it is possible to flexibly choose a new section or to reuse an already used section, depending on the direction of rotation of the first roller 201 controlled by the user. In a specific embodiment, the rotation of the first barrel 201 is controlled, for example, by the user. The contact friction of the collecting hair region 400 is utilized so that the first barrel 201 is rotated passively. This approach eliminates the cost of automatic control of the first barrel 201 and allows for more autonomous control with manual operation as needed for use. The first barrel 201 and the collecting hair component 300 are placed in different positions of the collecting hair region 400. The collecting hair component 300 (the adhering paper) can be replaced flexibly by rolling forward or rolling backward, which is more flexible and more automatic than the current manual tearing down and replacing paper. Especially for the large-area hair collecting or suction scene, the use convenience is stronger.

It should be noted that in different embodiments, when the collecting hair component 300 is rotated clockwise or counterclockwise in the first rolling direction, the second barrel 202 can also be synchronously rotated clockwise or counterclockwise, which is not limited to the forgoing example of synchronous rotation of the collecting hair component and the second barrel in the same direction. Depending on the different ways that the free end of the collecting hair component 300 is passed through and wound, when the collecting hair component 300 is rotated clockwise, the second barrel 202 is rotated counterclockwise and can be disengaged from (wound) the free end. Without limiting a relative relationship too much here, depending on the different rotation directions of the first barrel 201, the collecting hair component 300 can be flexibly rewound or unwound. However, according to the different rotation directions of the first barrel 201, i.e. clockwise or counterclockwise rotation, only the action of rewinding or unwinding the collecting hair component 300 can be realized correspondingly, which ensures the realization of the whole operation mode.

In some embodiments, to ensure the smoothness of the movement of the collecting hair component 300 and to avoid creases and knots in the process of rewinding or unwinding. The axes of the first barrel 201 and second barrel 202 are parallel to each other. in addition, the clockwise and counterclockwise rotation directions of the first barrel 201 and the second barrel 202 are parallel to each other, which can ensure the adhering paper of the collecting hair component 300 to be reciprocally moved in the direction of a general plane. This is not easy to have creases, knots and other situations.

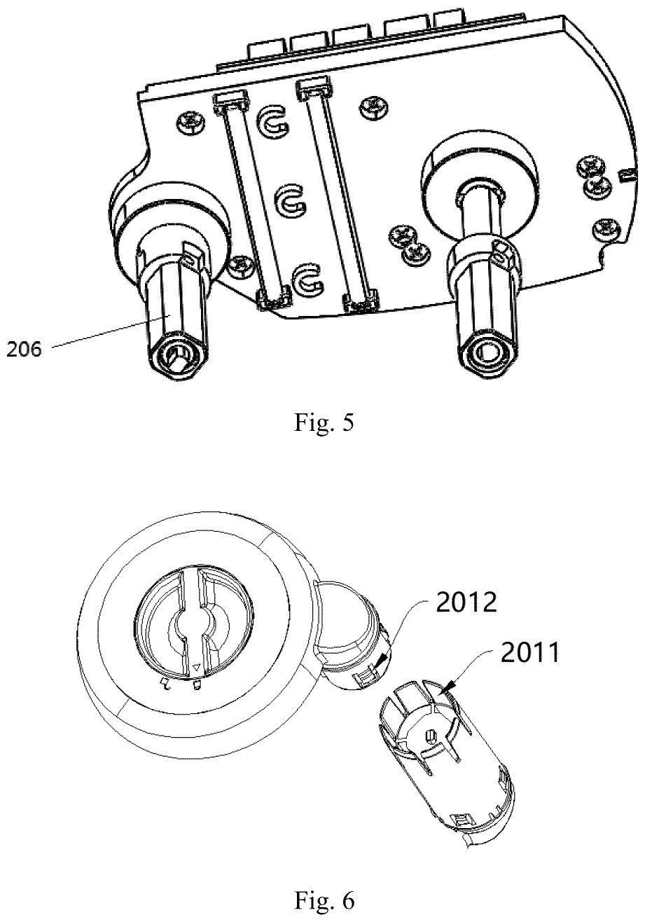

In addition, in some embodiments, the first barrel 201 is provided therein with an elastic damping structure 206, and/or, the second barrel 202 is provided therein with the elastic damping structure 206, i.e., it means that at least one of the first barrel 201 and the second barrel 202 is provided therein with the elastic damping structure 206. For example, the first barrel and the second barrel are provided with the elastic damping structure 206, the elastic damping structure 206 can prevent the first barrel 201 and the second barrel 202 from idling. Referring to FIG. 5, for example, the elastic damping structure 206 takes a combined structure of a spring and a support shaft. The support shaft is sleeved inside the corresponding barrel. The spring is sleeved on the support shaft. The outer wall of the support shaft and the inner wall of the corresponding barrel are fixed with the two ends of the spring, respectively, thereby avoiding the first barrel 201 and the second barrel 202 from idling and providing a surplus of rotation and greater stability. In a more specific embodiment, the elastic damping structure 206 is, for example, a combined structure of a snap spring, the spring, a sleeve and the support shaft. The sleeve is sleeved on the inner wall of the corresponding barrel. The spring is fixed on the outer wall of the support shaft and on the inner wall of the corresponding sleeve. The snap spring is mounted inside the sleeve.

To avoid the easy disengagement of the collecting hair component 300 from the first connecting part and/or the second connecting part, see FIGS. 1 and 3, in an optional embodiment, the first barrel 201 includes a first barrel body and a first position limiting cover movably snap-fitted to one end of the first barrel; and/or, the second barrel 202 includes a second barrel body and a second position limiting cover movably snap-fitted to one end of the second barrel. For example, both the first barrel 201 and the second barrel 202 are provided with the position limiting cover. The opening ends of the barrel bodies of the first barrel 201 and the second barrel 202 are a sleeved entrance end of the collecting hair component 300. After being sleeved, the position limiting cover is movably snap-fitted (Relative rotation is retained on the basis of a movable snap-fit between the barrel body and the position limiting cover, e.g. by means of a bearing connection, which ensures smooth rotation), which prevents the collecting hair component 300 from being disengaged out of the corresponding connecting part of the barrel body. It should be noted that the corresponding connecting parts of the first barrel 201 and the second barrel 202 have a length basically the same as the width of the collecting hair component 300, so that the collecting hair component 300 can move more stably.

In a specific embodiment, to increase the degree of fit tightness between the first position limiting cover (the second position limiting cover) and the first barrel body (the second barrel body), the movable snap-fit manner of the first position limiting cover (the second position limiting cover) and the first barrel body (the second barrel body) can be realized by using elastic downward pressing snap-fit, i.e., the side wall of the open end of the first barrel body extends to form a plurality of first snap-fit strips 2011. The first snap-fit strips 2011 are arranged in an axial direction of the first barrel body. A first plug-in barrel (e.g., relative rotation of the first plug-in barrel and the first position limiting cover are rotated relative to each other by means of a built-in bearing) is provided on one side of the first position limiting cover, the first plugging barrel is equipped with first socket cylinder (e.g., the first socket cylinder is rotated relative to the first limit cover by means of a built-in bearing). The plurality of first elastic protrusions 2012 are provided on the first plug-in barrel. The first elastic protrusions 2012 are configured to be snap-fitted with the first snap-fit strips during the snap-fit; and/or the side wall of the open end of the second barrel extends to form a plurality of second snap fit strips. The second snap-fit strips are arranged in an axial direction of the second barrel body. The second plug-in barrel is provided on one side of the second position limiting cover (e.g., the second plug-in barrel and the second position limiting cover are rotated relative to each other by means of a built-in bearing). A plurality of second elastic protrusions are provided on the second plug-in barrel. The second elastic protrusions are configured to be snap-fitted with the second snap-fit strips during the snap-fit.

The above technical solution indicates that at least one of the first barrel body and the first position limiting cover as well as the second barrel body and the second position limiting cover can adopt a snap-fit manner of a snap-fit strip and the elastic protrusions. Specifically, taking as an example the first barrel body and the first position limiting cover, the opening end of the first barrel body extends for one section. An axial groove is formed on the side wall of an extended section along a circumference to form a plurality of sheet-shaped first snap-fit strips 2011, which have a more superior elastic deformation capability. The plug-in barrel is molded on the inner side of the first position limiting cover. The plug-in barrel is configured to insert into an inner hole of the first barrel body. A plurality of holes are circumferentially opened at the insertion end of the plug-in barrel. The first elastic protrusions 2012 are formed in each hole. When the insertion end of the plug-in barrel is inserted into the inner hole of the first barrel body, the first elastic protrusions 2012 are able to effectively hold up the first snap-fit strip 2011. Specifically, one end of the first elastic protrusions 2012 is connected to the wall of the hole, and the other end thereof is a free end. The free end is molded with a convex portion on the outer side thereof, which is capable of acting on the first snap-fit strip 2011 and effectively pushing the first snap-fit strip 2011 open, thereby enhancing the tightness of the first barrel body and the first position limiting cover.

With the above technical solution, the adhering paper of the collecting hair parts 300 can flexibly continue to be used or automatically switch the use objective, thereby improving the repeated utilization of the adhering paper and the ease of replacement. The collecting hair assembly 200 can be integrated in a hand-held, self-driven hair collector, so as to achieve the objective of not having to frequently replace the adhering paper. In this embodiment, for example, the collecting hair assembly is integrated into a hand-held hair collector. See FIGS. 2-5, this embodiment further provides a collecting hair machine. The collecting hair machine includes a housing 100 and the forgoing collecting hair assembly 200. The collecting hair assembly 200 refers to the ability to achieve “the objective of continuous operation of a collecting hair component in the form of double barrels, without frequent replacement of an adhering paper in a large-area hair collecting and suction scene”, which is the minimum complete combination solution of this effect.

Specifically, one side of the housing 100 is opened and provided with a collecting hair operating opening 102. The collecting hair assembly 200 is mounted in the housing 100. A first barrel 201 of the collecting hair assembly 200 is rotatably provided at the collecting hair operating opening 102. The first barrel 201 protrudes wholly or partially out of the collecting hair operating opening 102 so that the collecting hair component 300 can contact a collecting hair region 400. That is, it means that the whole collecting hair assembly 200 is integrated in an inner cavity of the housing 100. The collecting hair operating opening 102 on the housing 100 is configured to expose the first barrel 201 and the collecting hair component 300, so as to be able to smoothly contact the collecting hair region 400 for collecting hair and suction operation.

With the above technical solutions, the whole collecting hair machine not only has the above advantages of the collecting hair assembly 200, but also has a stronger integration, can provide certain protection to the first barrel 201 and the second barrel 202 and facilitate access to the collecting hair region 400, which is very suitable for the operator to operate manually and has more flexibility. In addition, in order to further increase the flexibility of operation, a handle 101 can be integrated in the housing 100. The handle 101 is located, for example, on the side of the housing 100 away from the collecting hair operating opening 102. Therefore, it is convenient for an operator to apply a force to control the first barrel 201 and the collecting hair component 300 at the collecting hair operating opening 102 to roll forward or backward, especially for hair adsorption, without blocking the operator's line of sight, and with more energy-saving. In a specific embodiment, the axis (or a length direction) of the handle 101 is parallel to the width direction of the collecting hair component 300, which makes the operation more effortless.

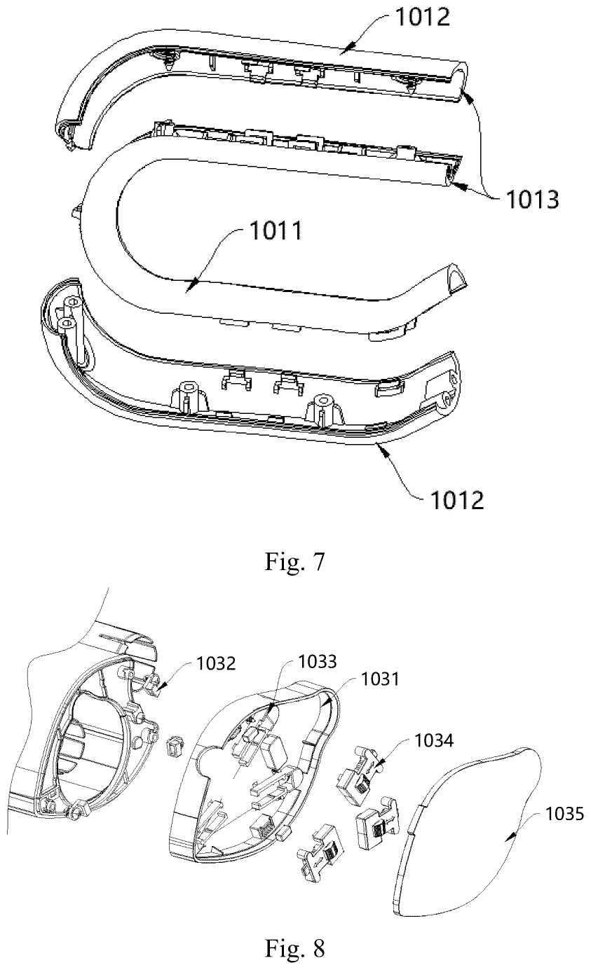

In a specific embodiment, please refer to FIG. 7, the handle 101 includes a first housing 1011 and a second housing 1012 that detachably cooperate with each other, that is, the first housing 1011 and the second housing 1012 can be spliced into the shape of the handle 101, such as I-shape, U-shape, S-shape, etc. Taking U-shape as an example, the first housing 1011 and the second housing 1012 are both U-shaped and can be spliced in one or more sections. As shown in FIG. 7, the second housing 1012 is spliced in two sections. The first housing 1011 is modeled in one section, which is not only convenient for splicing, but also convenient for disassembly and maintenance. The first housing 1011 and the second housing 1012 are provided with two free ends, respectively. The middle part thereof is configured to form a U-shaped bending opening. A plurality of snap-fit members can be sliced to form the U-shaped handle 101. After splicing, the U-shaped handle 101 has a U-shaped inner cavity. The two free ends thereof are spliced to form a connecting end 1013. The connecting end 1013 is embedded into the inner wall of the housing 100 for fixing, that is, one end of the first housing 1011 and one end of the second housing 1012 are connected to the inner wall of the housing 100 (such as by means of threading), which can ensure the aesthetics of the overall appearance of the handle 101.

On the basis of the above solution, in order to achieve a quick response of the second barrel 202 according to the direction of rotation of the first barrel 201 during hand-held collecting and suction, the collecting hair machine also includes a steering determining device connected to a controller via signals. The steering determining device is configured to detect the direction of autorotation of the first barrel 201, or in the rest of the embodiments, the steering determining device can also be a rotational speed determining device (the rotation speed determining device is configured to detect the rotation speed of the first barrel 201), or a combination of both, etc. there is no more limitation herein. The steering determining device can be an origin position sensor, an encoder or an angle sensor, etc. The objective is to determine the direction of rotation of the first barrel 201. In this example, the encoder, for example, is arranged at the end of a first barrel body of the first barrel 201 away from the first position limiting cover, and for example, is integrated at an internal support shaft, which is a simple and stable structure and more determined timely. In addition, the controller can also be integrated on the housing 100 near the side of the encoder for easy wire connection, and can be sealed with the outer cover 103 after installation, which ensures sealing and aesthetics. In some embodiments, to facilitate the operation of the steering determining device, the rotation speed determining device and the controller, the outer cover 103 needs to adopt a form of convenient disassembly and stable connection, such as a movable snap-fit or a turn-knob snap-fit. For details of the movable snap-fit manner, please refer to FIG. 8. The outer cover 103 includes an outer cover body 1031 and an outer cover plate 1035. The outer cover body 1031 is connected between the body of the housing 101 and the outer cover plate 1035. The body of the housing 101 is movably connected to the outer cover body 1031. The outer cover plate 1035 is movably connected to the outer cover body 1031.

A plurality of guide columns 1032 are fixed on the side wall of the body of the housing 101. A plurality of through holes that allow the guide columns 1032 to pass through are formed on the outer cover body 1031. A buckled female member 1033 is integrated at the through holes of the outer cover body 1031. A buckled slide groove is formed on the buckled female member 1033. The buckled submember 1034 is snap-fitted in the slide groove to be capable of being close to or away from slidingly a part through which the guide column 1032 passes. In addition, a jack is formed on the part passed by the guide column 1032 to snap-fit an inserting block formed by the buckled submember 1034. After the buckled submember 1034 slides in the buckled female member 1033 in a damping sliding manner step by step, the inserting block is inserted into the jack, so that the body of the housing 101 is movably snap-fitted with the outer cover body 1031. This manner not only has stable connection but also is easier to disassemble.

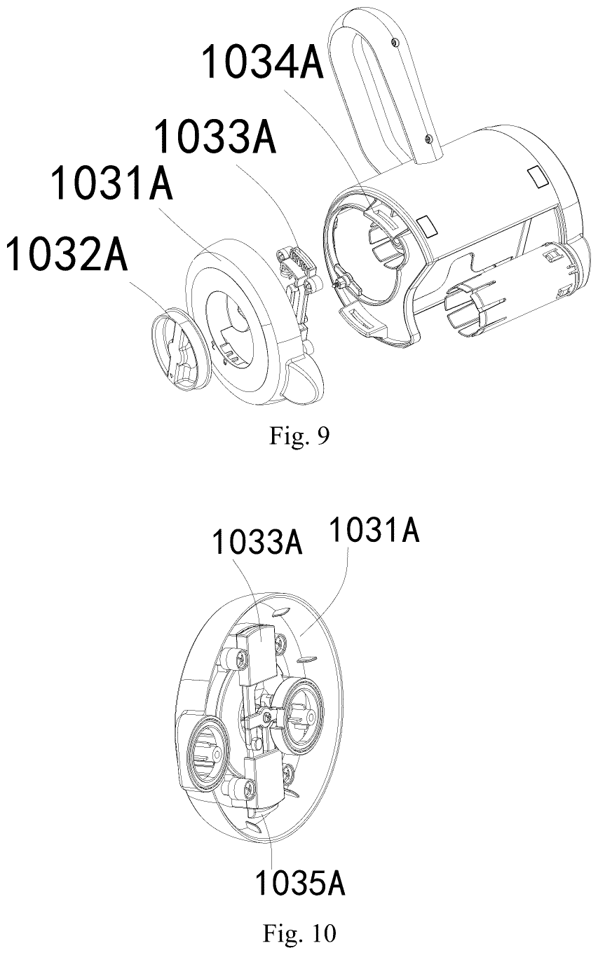

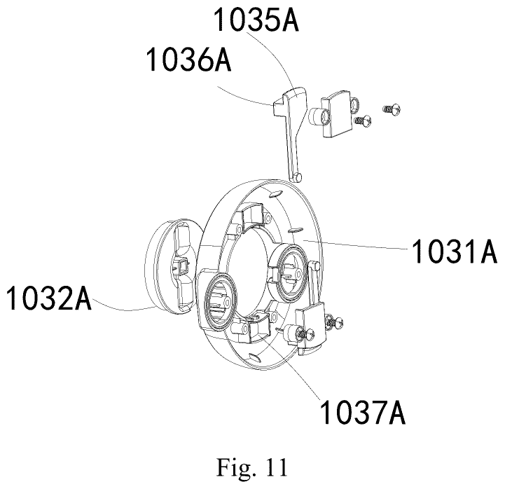

For details of the turn-knob snap-fit manner, please refer to FIG. 9 to FIG. 11. The outer cover 103 includes the outer cover body 1031A and a turn-knob 1032A arranged on 1031A. The upper and lower parts of the turn-knob 1032A are in contact with two groups of turn-lock assemblies, respectively. When in use, two groups of turn-lock assemblies 1033A can be driven by rotating the turn-knob 1032A. When the turn-knob 1032A is turned to a certain position, the turn-knob 1032A can drive the turn-lock assembly 1033A to contact the outer cover body 1031A for fixing, realizing the rapid removal of the outer cover body 1031A, and improving the convenience of use. The two groups of buckled columns 1034A are provided on the body of the housing 101. Two groups of turn-lock assemblies 1033A can be detachably snap-fitted together with the two groups of buckled columns 1034A. The body of the housing 101 corresponds to the positions of the two groups of turn-lock assemblies 1033A. Two groups of arc sliding seats 1037A are arranged. The turn-lock assembly 1033A includes a buckled member 1035A. One side of the buckled member 1035A is provided with one sliding block 1036A. The sliding block 1036A can realize sliding connection with a corresponding arc sliding seat 1037A. When a user slides a sliding block 1036A to one side of the arc slide seat 1037A, a buckled part of the buckled member 1035A extends into the buckled column 1037A to realize the locking state of the outer cover body 1031A. When the user slides the slide block 1036A to the other side of the arc slide seat 1037A, the buckled part of the buckled member 1035A is removed from the buckled column 1034A, so as to realize the unlocking state of the outer cover body 1031A.

Similarly, the driver 207 can be integrated on the inner wall of the housing 100 near the controller, for example on a mounting end 203 of the second barrel 202 (away from one end of the second position limiting cover). The mounting end 203 has a larger contact surface, thus facilitating the stable installation of the driver 207. For example, it should be noted that the first position limiting cover and the second position limiting cover are removably mounted on the housing movable cover on one side of the housing 100. The housing movable cover is configured to seal the exposed part of the first position limiting cover and the second position limiting cover, which, on the one hand, ensures aesthetics, and, on the other hand, is configured to form a space in which the first position limiting cover and the second position limiting cover are sealed, so as to avoid accidental ingress of ash and the like. Specifically, the housing movable cover and the body of the housing for mounting the first barrel 201 and the second barrel 202 are connected by means of a turn-lock manner (one of the first barrel 201 and the second barrel 202 is configured with a spiral groove, and the other of the first barrel 201 and the second barrel 202 is configured with a spiral thread, thereby realizing a rotary snap-fit), which provides a stable connection and is easy to disassemble and mount.

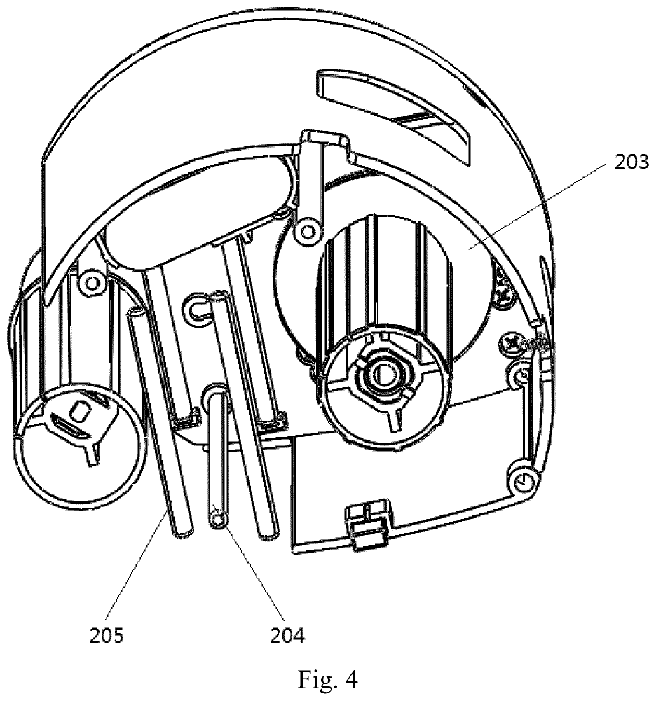

In some embodiments, please refer again to FIGS. 3 and 4, the housing 100 is provided with a tensioning roller 204. The tensioning roller 204 is located in the direction of a connecting line between the first barrel 201 and the second barrel 202. Here, the direction of the connecting line is the direction of a connecting line between the center point of the first barrel 201 and the second barrel 202 or a corresponding contour point. The tensioning roller 204 is located any position in a plane mapped by the section of the connecting line. For example, the tensioning roller 204 is arranged at the plane of movement of the free end of the collecting hair component 300. The two ends of the tensioning roller 204 are removably fixed to the inner wall of the housing 100. The middle of the tensioning roller 204 spans the free end of the collecting hair component 300, so that the tensioning roller 204 can tighten the part of the collecting hair component 300 connected between the first barrel 201 and the second barrel 202. Therefore, the collecting hair component 300 operates more stably.

In some embodiments, the housing 100 is provided therein with a deflection roller 205. The deflection roller 205 is configured to limit the part of the collecting hair component 300 connected between the first barrel 201 and the second barrel 202, thereby preventing the collecting hair component 300 from deviating from an original operating trajectory. Specifically, (the plurality of) deflection rollers 205 are fixed equally on both sides of the width direction of the free end of the collecting hair component 300 to limit the width direction of the free end of the collecting hair component 300. This ensures the flatness and smoothness of the operation of the part of the collecting hair component 300 between the first barrel 201 and the second barrel 202. And in some embodiments, the upper and lower ends of the deflection-correcting roller 205 are connected to the body of the housing 100 in a penetrating plug-in type (an inserted and penetrating part), i.e., the ends can be rotated and extend into the corresponding holes to realize the penetrating insertion connection, which is more stable in installation. Further, the axial rotation of the deflection correction is smoother, and the deflection correction effect is better. On the basis of the above solution, to realize the operations of adjustment, replacement, inspection, maintenance, etc. of the collecting hair component 200 inside the housing 100, the housing 100 is opened and provided with an operating opening connected to the inner cavity of the housing. The operating range of the operating opening covers at least the first barrel 201, the second barrel 202, and the middle connecting area between the first barrel 201 and the second barrel 202, i.e. it means that The region covered by the oblique projection direction of the operating opening facilitates the operation of the first barrel 201, the second barrel, 202 and the region connected between the first barrel and the second barrel by the operator. In addition, the housing 100 is connected to a sealing cover 104 that movably seals and covers the operating opening. Specifically, the sealing cover 104, for example, has a magnetic flapping structure that can be flexibly opened or closed. Therefore, the position of the collecting hair component 300 can be adjusted in real time. The first barrel 201 and the second barrel 202 can be maintained or replaced.

In some embodiments, the housing 100 can also be provided with a sterilization device, such as a UV sterilization device. The sterilization device can be arranged close to the collecting hair operating opening 102 to facilitate irradiation of the collecting hair region 400. On this basis, the outer wall of the housing 100 near the collecting hair operating opening 102 can be provided with a pressure sensing device. When hairs are collected and sucked, the outer wall of the housing 100 contacts the collecting hair region 400. The pressure sensing device works and transmits pressure signals to the controller. The controller gives instructions for the sterilization device to work.

In summary, in the specific embodiment of the collecting hair machine provided in this embodiment, the collecting hair component 300 (the adhering paper is sleeved at a paper tube) is sleeved on the first barrel 201. The free end of the adhering paper is fixed (glued) on the second barrel 202. The steering determining device collects the steering signals of the first barrel 201 and feeds the steering signals back to the controller. According to a preset logic, the controller controls the driver 207 to rotate clockwise or counterclockwise to executing a rewinding or unwinding action. Please combine with Fig. and FIG. 2, for example, when the collecting hair machine is pushed forward, the steering determining device receives the signals and feeds the signals back to the controller. The controller drives the driver 207 to start. The second barrel 202 rewinds the paper. When the collecting hair machine is pulled backward, the first barrel 201 is rotated clockwise. The paper rewound in the second barrel 202 is reversely wound to the first barrel 201. Therefore, a user can change the directions (actually different rotation directions of the first barrel 201) of pushing and pulling according to actual needs to realize the repeated use for the adhering paper full of the hairs, or enable a new adhering paper.

The forgoing descriptions are only preferred embodiments of the present invention, and are not used to limit the present invention. For the person skilled in the art, the present invention can have various modifications and changes. Any modification, equivalent replacement and improvement made within the spirit and principle of the present invention should be included within the protection scope of the present invention. It should be noted that the structures or components illustrated in the drawings are not necessarily drawn to scale, while the present invention omits descriptions of well-known components and processing techniques and processes in order to avoid unnecessary limitation to the present invention.

What is claimed is:

1. A collecting hair assembly, comprising:
a first barrel having a first connecting part for being sleeved at a collecting hair component, and the first barrel being capable of being rotated along an axis of the first barrel so that the collecting hair component is capable of reciprocally contacting a collecting hair region in a first rolling direction;
a second barrel having a second connecting part connected to a free end of the collecting hair component, the second barrel being provided with a driver, and the driver being capable of driving the second barrel to auto-rotate along an axis of the second barrel so that the free end is capable of being wound or disengaged from the second barrel in a second rolling direction; and
a controller being connected to the driver via signals for controlling operation of the driver when the controller is triggered by the signals;
wherein the free end is capable of being selectively wound or disengaged from the second barrel when the collecting hair component is rotated clockwise or counterclockwise in the first rolling direction in a signal-triggered state.

2. The collecting hair assembly according to claim 1, wherein the axes of the first barrel and the second barrel are parallel to each other.

3. The collecting hair assembly according to claim 1, wherein the first barrel is provided therein with an elastic damping structure;
wherein the elastic damping structure comprises a support shaft and a spring, the support shaft is coaxially arranged inside a corresponding barrel, and the spring is fixed between the support shaft and the corresponding barrel;
and/or, the second barrel is provided therein with the elastic damping structure.

4. The collecting hair assembly according to claim 1, wherein the first barrel comprises a first barrel body and a first position limiting cover movably snap-fitted to an opening at one end of the first barrel body;
and/or, the second barrel comprises a second barrel body and a second position limiting cover movably snap-fitted to an opening at one end of the second barrel body.

5. The collecting hair assembly according to claim 4, wherein a side wall of an open end of the first barrel body extends to form a plurality of first snap-fit strips, the first snap-fit strips are arranged in an axial direction of the first barrel body, a first plug-in barrel is provided on one side of the first position limiting cover, a plurality of first elastic protrusions are provided on the first plug-in barrel, the first elastic protrusions are configured to be snap-fitted with the first snap-fit strips during snap-fit;
and/or, a side wall of an open end of the second barrel body extends to form a plurality of second snap-fit strips, the second snap-fit strips are arranged in an axial direction of the second barrel body, a second plug-in barrel is provided on one side of the second position limiting cover, a plurality of second elastic protrusions are arranged on the second plug-in barrel, and the second elastic protrusions are configured to be snap-fitted with the second snap-fit strips during the snap-fit.

6. A collecting hair machine, comprising a housing and the collecting hair assembly according to claim 1, one side of the housing is opened and provided with a collecting hair operating opening; the collecting hair assembly is mounted in the housing, a first barrel of the collecting hair assembly is rotatably arranged at the collecting hair operating opening, and the first barrel protrudes wholly or partially out of the collecting hair operating opening so that the collecting hair component is capable of contacting a collecting hair region.

7. The collecting hair machine according to claim 6, further comprising a steering determining device connected to the controller via signals, and the steering determining device being configured to detect an autorotation direction of the first barrel.

8. The collecting hair machine according to claim 7, wherein the housing is provided thereon with an outer cover for protecting the steering determining device, and the outer cover is movably snap-fitted with the housing.

9. The collecting hair machine according to claim 8, wherein the housing is rotationally snap-fitted with a housing movable cover, and the housing movable cover and the outer cover are located on two sides of the housing, respectively.

10. The collecting hair machine according to claim 6, wherein the housing is provided with a tensioning roller, the tensioning roller is located in a direction of a connecting line between the first barrel and the second barrel, and the tensioning roller is configured to tension a part of the collecting hair component connected between the first barrel and the second barrel.

11. The collecting hair machine according to claim 6, wherein the housing is provided therein with a deflection roller, and the deflection roller is configured to limit the part of the collecting hair component connected between the first barrel and the second barrel.

12. The collecting hair machine according to claim 11, wherein upper and lower ends of a deflection-correcting roller are connected to the housing in a penetrating plug-in manner.

13. The collecting hair machine according to claim 6, wherein the housing is opened and provided with an operating opening connected to an inner cavity of the housing, and an operating range of the operating opening covers at least the first barrel, the second barrel and an intermediate connecting region between the first barrel and the second barrel.

14. The collecting hair machine according to claim 13, wherein the housing is connected to a sealing cover that movably seals and covers the operating opening.

15. The collecting hair machine according to claim 6, wherein the housing is integrated with a handle, the handle is located on a side of the housing away from a collecting hair operating opening; the handle comprises a first housing and a second housing that are capable of removably cooperating with each other, and one end of the first housing and one end of the second housing are connected to an inner side wall of the housing.

16. The collecting hair machine according to claim 6, wherein the first barrel and/or the second barrel is connected to the housing via a bearing.
